(19) United States
(12) Patent Application Publication
(10) Pub. No.: US 2010/0229698 A1
(43) Pub. Date: Sep. 16, 2010

(54) WIRE PULLING AND TENSIONING TOOL

(75) Inventors: Brian Edward Shawcross, Nottinghamshire (GB); Neil Clarke, Sheffield (GB)

Correspondence Address: CLARK HILL PLC, 150 NORTH MICHIGAN AVENUE, SUITE 2700, CHICAGO, IL, 60601, US

(73) Assignee: GRIPPLE LIMITED, Sheffield (GB)

(21) Appl. No.: 12/664,569

(22) PCT Filed: Jun. 4, 2008
(86) PCT No.: PCT/GB2008/001884

§ 371 Date: Jan. 21, 2010

(30) Foreign Application Priority Data
Aug. 3, 2007 (GB) 0715127.7

(51) Int. Cl. B25B 25/00

(52) U.S. Cl. 81/486; 254/241

(57) ABSTRACT

A tool for pulling a wire (W) through a connector (C) or a terminal has a pair of levers (20, 24) pivoted together, one lever (20) having an abutment portion (23) for location of the connector (C) and the other lever (24) having clamping members (26, 28) for gripping the wire (W), characterised in that one lever (24) has a handgrip portion (25) articulated to a shank portion (40) for movement between an in-line position and a position inclined towards the handgrip portion (22) of the other lever (20), spring-loaded latching means (45) being provided between the handgrip portion (25) and the shank portion (40) for disengagement when the tension in the wire (W) reaches a value set by a knob (72) for loading the spring means and indicated by a pointer (73) against a scale (74).

This invention relates to a wire pulling and tensioning tool.

There are numerous instances where wire needs to be pulled in a required direction and tensioned.

Thus, with such as wire mesh fencing, horizontal support strands of wire are provided between support posts and which, after being secured to a first post and carried to an endmost post, need to be tensioned between the posts. In another instance, such as in the growing of vines, a considerable number of horizontal strands of wire are needed to provide support for the vines over their height. Again, the lengths of wire are secured to a first post and carried to an endmost post, with the need for the lengths of wire to be tensioned between the posts. The wires may be secured in tension by anchoring to the endmost post; or the wires may be looped round the endmost post and each provided with a terminal through which both the strand and the end pass and in which the end is gripped, pulling of the end through the terminal applying the tension to the strand.

Likewise, successive lengths of wire may need to be connected together to form support strands of greater overall length than the individual wire lengths, a connector being provided for adjacent ends of successive lengths of a support strand, with the wire ends passing through the connector from opposite ends and gripped therein, pulling of one end through the connector applying tension to the strand if need be. Such a connector is described in WO 89/02994 and may be used alternatively as a terminal in the manner described above.

WO91/04137 discloses a wire pulling and tensioning tool comprising a first lever having a first pivot intermediate a first handgrip portion and an abutment portion, a second lever pivoted by the first pivot to the first lever intermediate a second handgrip portion and a first clamping member on at least one side of the second lever, a second pivot on the second lever intermediate the first pivot and the first clamping member, a second clamping member on the second pivot on at least the same side of the second lever as the first clamping member, the second clamping member being spring-loaded to a stop position towards the abutment portion of the first lever, and first and second wire-engaging faces on the first and second clamping members respectively, the second wire-engaging face being arcuate but non-concentric with the second pivot and whereby as the second clamping member is urged towards its stop position the minimum gap between the first and second wire-engaging faces diminishes, the abutment portion having a first abutment face adapted to press against the second clamping member when the handgrip portions of the levers are moved away from each other so as to increase the minimum gap between the wire-engaging faces for insertion therebetween of any wire up to a maximum diameter, and the abutment portion having a second abutment face facing oppositely to the first abutment face for abutment by a terminal or connector with respect to which the wire is to be pulled when the handgrip portions of the levers are moved towards each other, stop means being provided between the levers whereby closing movement of the handgrip portions is limited so as to ensure clearance between hands gripping them.

As the handgrip portions of the levers are initially moved towards each other the first abutment face is carried away from contact with the second clamping member thus allowing the second wire-engaging face to be urged towards the first wire-engaging face to effect an initial grip on a wire inserted therebetween, and as the handgrip portions continue to be moved towards each other tension in the wire and friction between it and the wire-engaging faces will bring about a greater grip on the wire. The second wire-engaging face, at least, is provided with teeth or serrations, to enhance the grip.

The abutment portion of the first lever may be provided with a notch for location of a wire extending from a terminal or connector to between the clamping members on the second lever, whereby the terminal or connector is located against the second abutment face. Alternatively, or preferably in addition, the second abutment face is recessed for receipt of one end of a terminal or connector.

It is also known, though not published in any patent document, for the first lever to be jointed at a third pivot between a first shank portion carrying the first handgrip portion and a bracket portion carrying both the abutment portion and the first pivot, with a first arcuate gear portion at the end of the first shank portion remote from the first handgrip portion, and for the second lever to be provided with a second shank portion carrying the second handgrip portion and a second arcuate gear portion concentric with the first pivot and meshing with the first arcuate gear portion, whereby the length and extent of opening and closing of the handgrip portions are greatly reduced, the stop means for limiting closing movement of the handgrip portions being provided between the shank portions.

Repeated operation of either wire pulling and tensioning tool will, if need be, progressively pull a wire with respect to a terminal or connector until the wire is tensioned, but it may be difficult to ascertain the amount of tension applied.

The object of the present invention is, therefore, to provide a wire pulling and tensioning tool as initially defined (or as later modified) with means for setting and indicating tension applied to a wire.

According to the present invention, the wire pulling and tensioning tool has the handgrip portion of one lever provided with and articulated to a shank portion for movement between an in-line position and a position inclined towards the handgrip portion of the other lever; disengageable latching means between the handgrip portion and the shank portion and which is engaged when the handgrip portion is in line with the shank portion, spring means within the handgrip portion urging the latching means towards engagement, adjustment means on the handgrip portion for setting the loading of the spring means on the latching means, and scale means associated with the adjustment means for indicating the load settings.

It will be appreciated that the loading of the latching means by the spring means determines the closing force needed to be applied to the levers through the handgrip portions to disengage the latching means, which in turn determines the limiting tension that will have been applied to a wire being pulled by the tool if the latching means is disengaged before the stop means between the levers becomes engaged. If the said stop means becomes engaged before the latching means disengages then the limiting tension has not been reached, so repeated operation of the tool will be necessary.

Re-engagement of the latching means is effected by moving the handgrip portions of the levers away from each other, possibly even until the abutment portion on the first lever presses against the second clamping member on the second lever, which also causes an increase in the gap between the wire-engaging faces and so allows the tool to be removed from the tensioned wire and the connector or terminal through which it has been pulled.

The disengaging and re-engaging of the latching means is accompanied by audible clicks, thus adding to the visual indication as the handgrip portion moves out of or into alignment respectively with the shank portion.

Articulation of the handgrip portion to the shank portion may be afforded by mounting the handgrip portion on a shaft extending from a transverse pivot within the shank portion, with an interface between the handgrip portion and the shank portion (which interface may be formed as a part-cylindrical surface having the pivot axis as its centre of curvature), there being an aperture in the end face of the shank portion for passage of the shaft, (which aperture may be a slot for limiting the swing of the shaft and with it the handgrip portion), and the latching means being incorporated at the interface.

The latching means may comprise at least two balls symmetrically disposed one to either side of the shaft and each housed in a socket in the end face of the handgrip portion and, when the handgrip portion is in line with the shank portion, protruding slightly into the rim of a hole having a diameter less than the ball in the end face of the shank portion.

Alternatively, and preferably, the latching means comprises at least one cylindrical bar disposed with its axis parallel to the axis of the pivot of the shaft and housed in a groove in the end face of the handgrip portion and, when the handgrip portion is in line with the shank portion, protruding into a groove in the end face of the shank portion. The bar-and-grooves latching means affords greater bearing contact than the balls-and-holes latching means, thus reducing the likelihood of wear due to repeated operation.

It is preferable to provide a second cylindrical bar in parallel with the first cylindrical bar, with the second cylindrical bar housed in a groove in a lateral extension of the end of the shank portion and, when the handgrip portion is in line with the shank portion, protruding into a groove in a lateral extension of the end of the handgrip portion. The provision of duplicated bar-and-grooves latching means affords a greater loading range relative to a set spring rating. The groove in the laterally extended end of the handgrip portion for the second bar preferably has a tangential ramp towards the first bar up towards a stop for the second bar when the latching means becomes disengaged, which contact enhances the audible click upon disengagement.

The lateral extensions preferably extend towards the other handgrip portion, for compactness, and may constitute stop means between the handgrip portions, additional or alternative to stop means between the shank portions, preferably with complementary (lesser) stop means at the juncture of the handgrip and shank portions of the other lever to guard against trapping of fingers between the two stop means.

The laterally extended end of the handgrip portion preferably has upstanding flanges along its sides to retain the cylindrical bars in their respective grooves, and the flanges are slidably located in grooves in the laterally extended end of the shank portion, to guide the handgrip portion in its movements relative to the shank portion; and outer flanks of the grooves are preferably contiguous with a semicircular skirt portion on the end face of the shank portion and lying outside an upstanding semicircular flange portion on the end face of the handgrip portion contiguous with the flanges thereon, to preclude ingress of dirt into the latching means.

The spring means is preferably a helical coil compression spring encircling the shaft within the handgrip portion, one end of the spring abutting an annular shoulder within the handgrip portion facing oppositely to the end face of the handgrip portion and the other end abutting an annular member slidable on the shaft and backed by a nut screwing along a threaded end portion of the shaft, the nut being slidable but non-rotatable in a blind hole (e.g. of hexagonal cross-section) in an end-cap captive in the handgrip portion and rotatable with respect to the handgrip portion for effecting axial movement of the nut and annular member for adjusting the loading of the spring, and the annular member having a pointer projecting radially through an axial slot in one side of the handgrip portion to register against a scale indicative of the tension to be applied to a wire.

The articulation between a handgrip portion and a shank portion is preferably provided on the second lever, especially when the first lever is jointed at a third pivot as described previously.

An embodiment of the invention and an alternative form of latching means will now be described, by way of example only with reference to the accompanying drawings in which

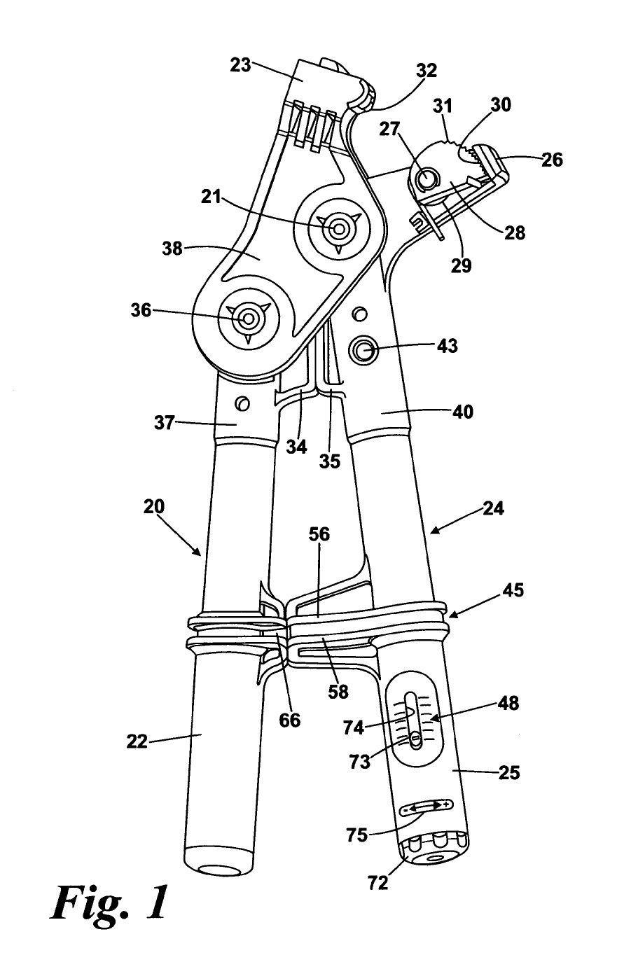

FIG. 1 is a half-size front perspective view of a wire pulling and tensioning tool in accordance with the invention;

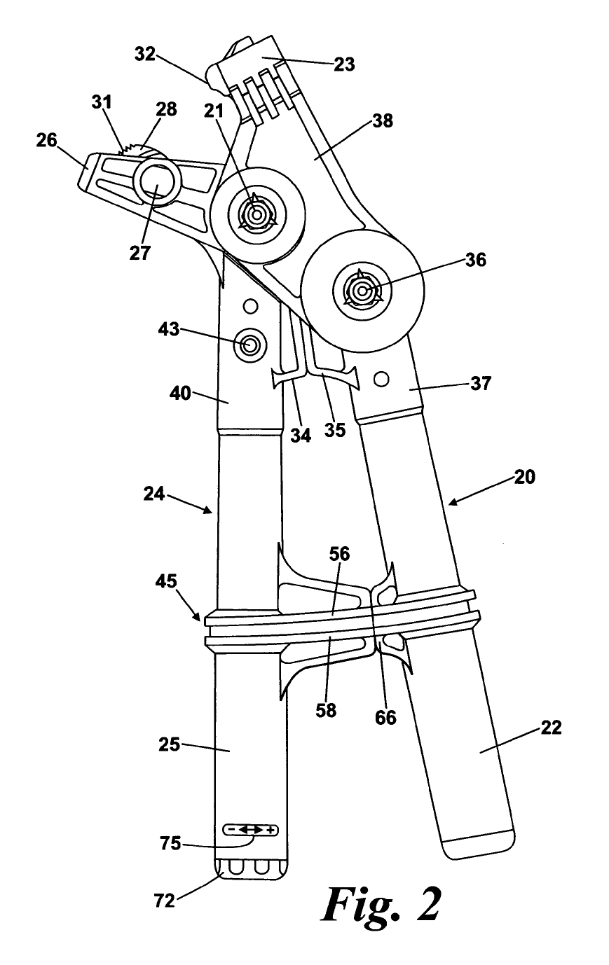

FIG. 2 is a rear elevation of the tool;

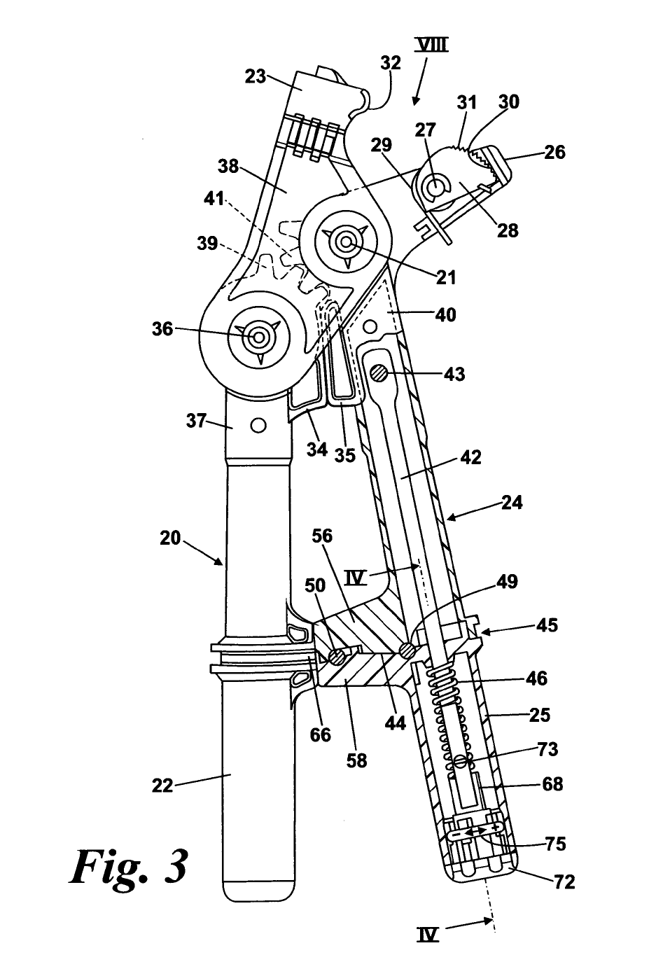

FIG. 3 is a front elevation of the tool partially in section to show the latching means and load setting means;

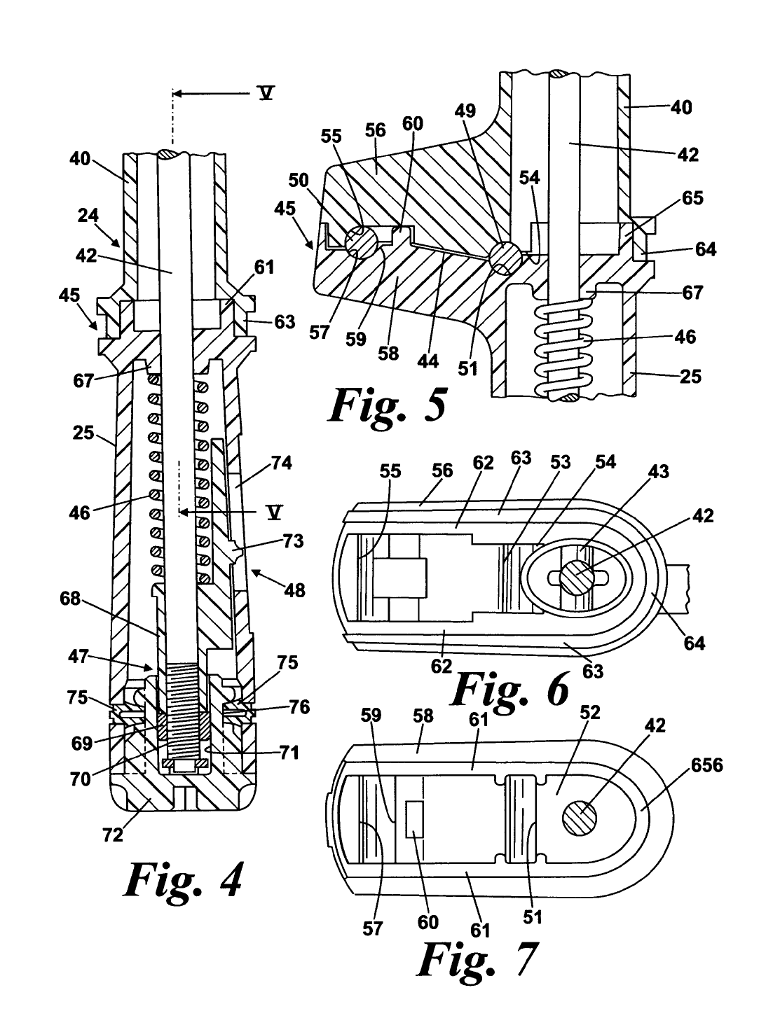

FIG. 4 is a full-size section taken from the line IV-IV of FIG. 3;

FIG. 5 is a full-size section taken from the line V-V of FIG. 4, showing the latching means in engagement;

FIG. 6 is an elevation of the underside of the upper moulding of FIG. 5;

FIG. 7 is an elevation of the upper side of the lower moulding of FIG. 5;

FIG. 8 is a full-size elevation of the upper parts of the tool as seen in the direction of the arrows VIII of FIG. 3;

FIG. 9 is a half-size fragmentary front elevation of the upper parts of the tool showing how the tool is applied initially to a connector for successive lengths of fencing or trellis wires, to be tensioned;

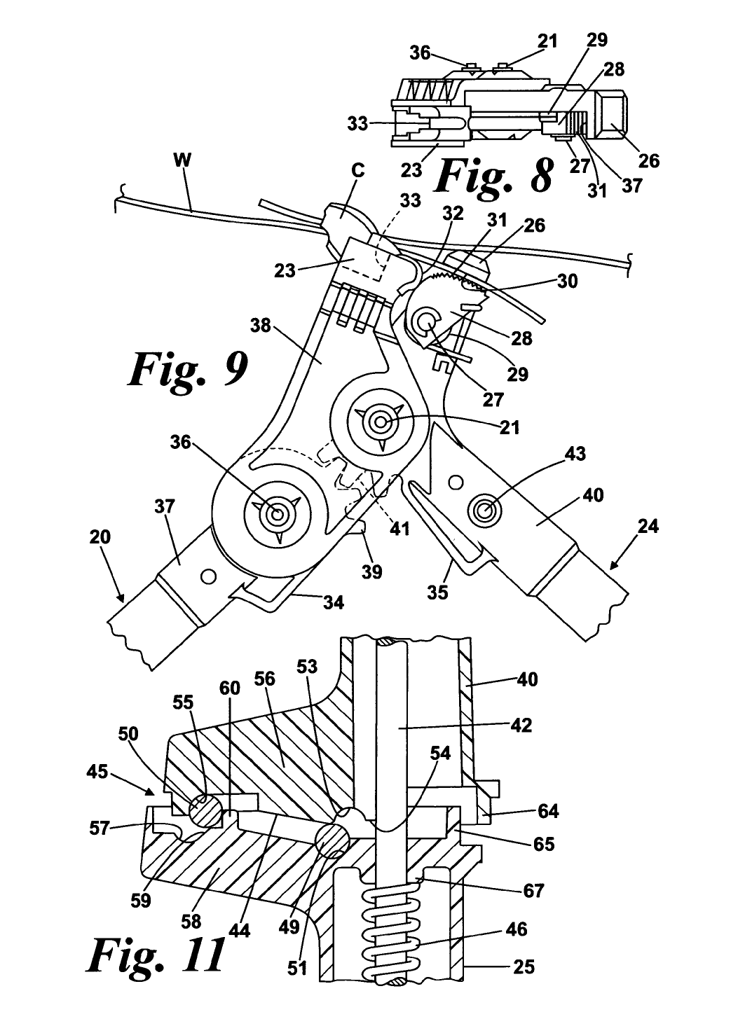

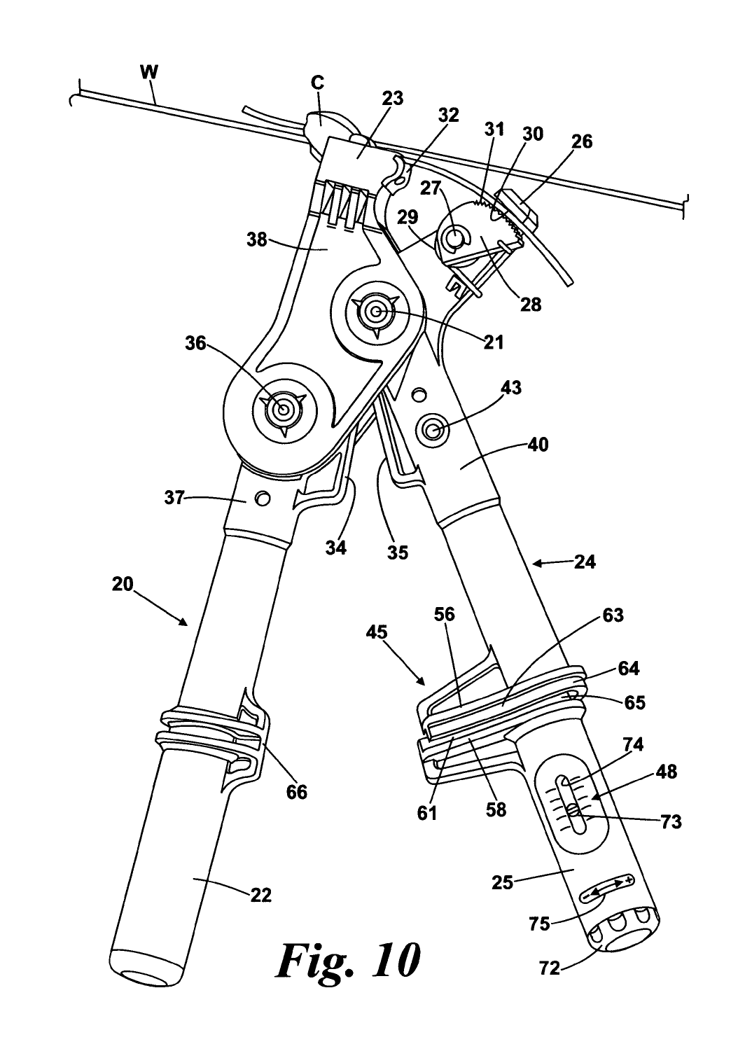

FIG. 10 is a half-size front elevation of the tool showing its condition upon tension in the connected wires reaching a set value;

FIG. 11 corresponds to FIG. 5 but shows the disposition of the latching means when disengaged upon tension in connected wires reaching a set value;

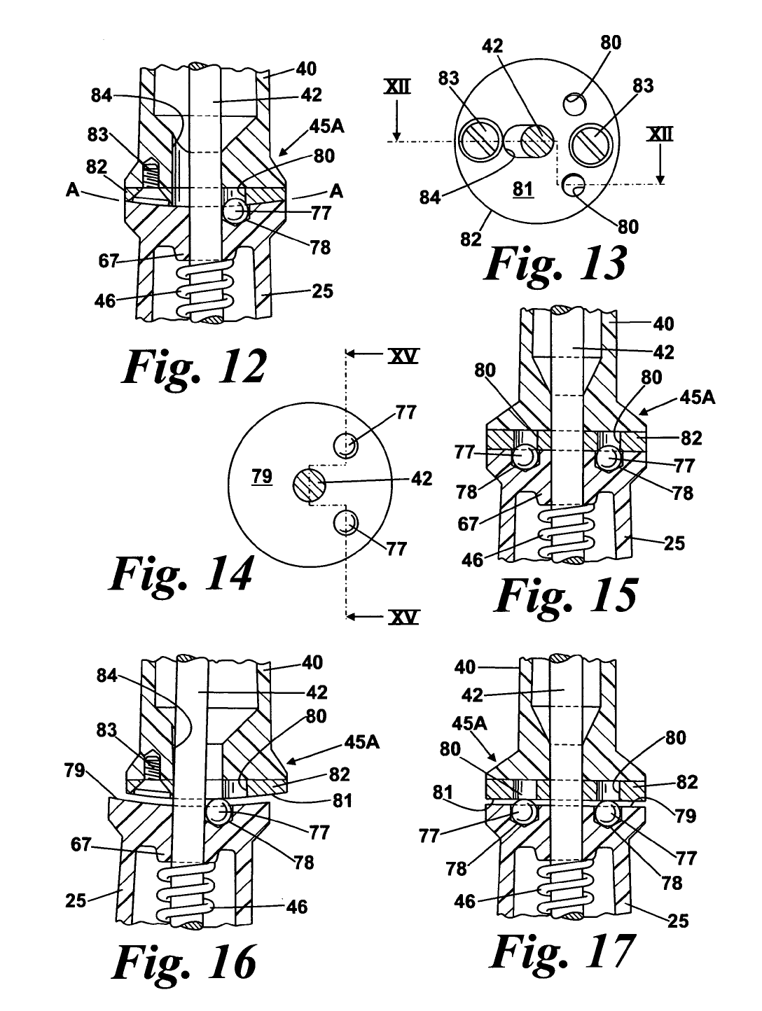

FIG. 12 is full-size fragmentary section corresponding to FIG. 5 but showing an alternative form of latching means in engagement;

FIG. 13 is a part-sectional elevation looking upwards from the curved line A-A of FIG. 12, which section is taken from the line XII-XII in FIG. 13;

FIG. 14 is a part-sectional elevation looking downwards from the curved line of FIG. 12;

FIG. 15 is a fragmentary section taken from the line XV-XV in FIG. 14; and

FIGS. 16 and 17 correspond to FIGS. 12 and 15 respectively but showing the disposition of the alternative form of latching means when disengaged.

The tool shown in FIGS. 1 to 11 comprises a first lever 20 having a first pivot 21 intermediate a first handgrip portion 22 and an abutment portion 23, a second lever 24 pivoted by the first pivot to the first lever intermediate a second handgrip portion 25 and a first clamping member 26 on one side of the second lever, a second pivot 27 on the second lever 24 intermediate the first pivot 21 and the first clamping member 26, a second clamping member 28 on the second pivot 27 on the same side of the second lever 24 as the first clamping member 26, the second clamping member 28 being spring-loaded by a coil spring 29 to a stop position towards the abutment portion 23 of the first lever 20, and first and second wire-engaging faces 30, 31 on the first and second clamping members 26, 28 respectively. The second wire-engaging face 31 being arcuate but non-concentric with the second pivot 27 and whereby as the second clamping member 28 is urged towards its stop position the minimum gap between the first and second wire-engaging faces 30, 31 diminishes, the abutment portion 23 on the first lever 20 having a first abutment face 32 adapted to press against the second clamping member 28 when the handgrip portions 22, 25 are moved away from each other (see FIG. 9) so as to increase the minimum gap between the wire-engaging faces 30, 31 for insertion therebetween of any wire W up to a maximum diameter, and the abutment portion 23 having a second abutment face 33 (FIGS. 8 and 9) facing oppositely to the first abutment face 32 and within a recess for abutment by a terminal or connector C (see FIGS. 9 and 10) with respect to which the wire W is to be pulled when the handgrip portions 22, 25 are moved towards each other, movement of the second clamping member 28 away from the abutment portion 23 allowing that clamping member to be urged by the spring 29 towards the first clamping member 26 to grip the wire W, for enhancement of which grip the arcuate face 31 of the second clamping member is provided with teeth or serrations, and stop means 34, 35 being provided between the levers 20, 24 whereby closing movement of the handgrip portions 22, 25 is limited so as to ensure clearance between hands gripping them.

The first lever 20 is jointed at a third pivot 36 between a first shank portion 37 and a bracket portion 38 carrying both the abutment portion 23 and the first pivot 21, with a first arcuate gear portion 39 (FIGS. 3 and 9) at the end of the first shank portion, and the second lever is provided with a second shank portion 40 carrying both the clamping members 26, 28 and with a second arcuate gear portion 41 concentric with the first pivot 21 and meshing with the first arcuate gear portion 39, whereby the length and extent of opening and closing of the handgrip portions 22, 25 are greatly reduced, the stop means 34, 35 for limiting closing movement of the handgrip portions being provided between the shank portions 37, 40.

In accordance with the present invention, the handgrip portion 25 of the lever 24 is articulated to the shank portion 40 by mounting the handgrip portion 25 on a shaft 42 extending from a transverse pivot 43 within the shank portion 40, with an interface 44 between the handgrip portion and the shank portion, for movement between an in-line position (FIGS. 1 to 3) and a position inclined towards the handgrip portion 22 of the lever 20 (see FIG. 10), disengaging latching means 45 between the handgrip portion 25 and the shank portion 40 and which is engaged when the handgrip portion is in line with the shank portion (see particularly FIGS. 3 to 5), spring means 46 within the handgrip portion urging the latching means towards engagement, adjustment means 47 on the handgrip portion for setting the loading of the spring means on the latching means, and scale means 48 associated with the adjustment means for indicating the load settings.

The loading of the latching means 45 by the spring means 46 determines the closing force to be applied to the levers 20, 24 through the handgrip portions 22, 25 to disengage the latching means (FIGS. 9 to 11), which in turn determines the limiting tension that will have been applied to a wire W being pulled by the tool if the latching means is disengaged before the stop means 34, 35 becomes engaged. If the said stop means becomes engaged before the latching means 45 disengages then the limiting tension has not been reached, so repeated operation of the tool (to FIG. 9 and then FIG. 10) will be necessary.

Re-engagement of the latching means 45 is effected by moving the handgrip portions 22, 25 of the levers 20, 24 away from each other, possibly even until the abutment portions 23 on the lever 20 presses against the clamping member 28 on the lever 24 (see FIG. 9), which also causes an increase in the gap between the wire-engaging faces 30, 31 and so allows the tool to be removed from the tensioned wire W and the connector C through which it has been pulled.

The disengaging and re-engaging of the latching means 45 is accompanied by audible clicks, this adding to the visual indication as the handgrip portion 25 moves out of or into alignment respectively with the shank portion 40.

The preferred embodiment of latching means 45 shown in FIGS. 3 to 7 and 11 comprises a pair of cylindrical bars 49, 50 disposed with their axes parallel to the axis of the pivot 43 of the shaft 42, the bar 49 being housed in a groove 51 in the end face 52 of the handgrip portion 25 and, when the handgrip portion is in line with the shank portion 40, protruding into a groove 53 in the end face 54 of the shank portion, while the bar 50 is housed in a groove 55 in a lateral extension 56 of the end of the shank portion 40 and, when the handgrip portion is in line with the shank portion, protruding into a groove 57 in a corresponding lateral extension 58 of the handgrip portion (see particularly FIGS. 5 to 7 and 11). The provision of duplicated bar-and-grooves latching means affords a greater loading range relative to a set spring rating than with the minimum latching means of one bar and grooves, and enables the handgrip portion 25 and shank portion 40 to be formed integrally with their respective lateral extensions 56, 58 to be formed of plastics, e.g. glass fibre reinforced nylon, while the bars 49, 50 are formed of metal, e.g. nickel coated stainless steel.

The groove 57 in the laterally extended end 58 of the handgrip portion 25 for the bar 50 has a tangential ramp 59 towards the bar 49 up towards a stop 60 for the second bar when the latching means 45 becomes disengaged, which contact enhances the audible click upon disengagement (see particularly FIG. 11).

The laterally extended end 58 of the handgrip portion 25 has upstanding flanges 61 along its sides to retain the cylindrical bars 49, 50 in their respective grooves, and the flanges are slidably located in grooves 62 in the laterally extended end 56 of the shank portion 40, to guide the handgrip portion in its movements relative to the shank portion (see FIG. 10); and outer flanks 63 of the grooves 62 are contiguous with a semicircular skirt portion 64 on the end face 54 of the shank portion 40 and lying outside an upstanding semicircular flange portion 65 on the end face 52 of the handgrip portion 25 contiguous with the flanges 61 thereon, to preclude ingress of dirt into the latching means.

The lateral extensions 56, 58 extend towards the handgrip portion 22, for compactness, and constitute stop means between the handgrip portions, additional to the stop means 34, 35 between the shank portions 37, 40 with complementary, lesser stop means 66 at the juncture of the handgrip portion 22 and shank portion 37 of the lever 20 to guard against trapping of fingers between these additional stop means.

Referring particularly to FIG. 4, it will be seen that one end of the helical coil compression spring 46 abuts an annular shoulder 67 within the handgrip portion 25 and the other end abuts an annular member 68 slidable on the shaft 42 and backed by a nut 69 screwing along a threaded end portion 70 of the shaft, the nut being slidable but non-rotatable in a blind hole 71, e.g. of hexagonal cross-section, in an end cap 72 captive in the handgrip portion and rotatable with respect thereto for effecting axial movement of the nut 69 and annular member 68 for adjusting of the loading of the spring 46, and the annular member has a pointer 73 projecting radially through an axial slot 74 in one side of the handgrip portion 25 to register against the scale 48 indicative of the tension applied to a wire W. The end cap 72 is held captive in the handgrip portion 25 by a pair of arcuate snap-in inserts 75 engaging a neck 76 in the end cap, which inserts are provided with indications, + and − and double ended arrows, of the directions in which the end cap needs to be rotated to increase or decrease the loading of the spring 46.

In FIGS. 12 to 17, showing an alternative form of latching means 45A, like parts to those in the preceding figures have like reference numerals. The latching means 45A comprise a pair of balls 77 symmetrically disposed one to either side of the shaft 42 and each housed in a socket 78 in the end face 79 of the handgrip portion 25 and, when the handgrip portion is in line with the shank portion 40, protruding slightly into the rim of a hole 80 having a diameter less than the ball in the end face 81 of the shank portion, which end face is provided on a metal plate 82 secured to the shank portion 40 by two countersunk screws 83. the interface 79, 81 between the handgrip portion 25 and the shank portion 40 is formed as a part-cylindrical surface having the axis of the pivot 43 as its centre of curvature, and there is a slot 84 in the end face 81 of the shank portion for limiting the swing of the shaft 42 and with it the handgrip portion 25.

1. A wire pulling and tensioning tool comprising a first lever having a first pivot intermediate a first handgrip portion and an abutment portion, a second lever pivoted by the first pivot to the first lever intermediate a second handgrip portion and a first clamping member on at least one side of the second lever, a second pivot on the second lever intermediate the first pivot and the first clamping member, a second clamping member on the second pivot on at least the same side of the second lever as the first clamping member, the second clamping member being spring-loaded to a stop position towards the abutment portion of the first lever, and first and second wire-engaging faces on the first and second clamping members respectively, the second wire-engaging face being arcuate but non-concentric with the second pivot and whereby as the second clamping member is urged towards its stop position the minimum gap between the first and second wire-engaging faces diminishes, the abutment portion having a first abutment face adapted to press against the second clamping member when the handgrip portions of the levers are moved away from each other so as to increase the minimum gap between the wire-engaging faces for insertion therebetween of any wire up to a maximum diameter, and the abutment portion having a second abutment face facing oppositely to the first abutment face for abutment by a terminal or connector with respect to which the wire is to be pulled when the handgrip portions of the levers are moved towards each other, stop means being provided between the levers whereby closing movement of the handgrip portions is limited so as to ensure clearance between hands gripping them, characterised in that the handgrip portion of one lever is provided with and articulated to a shank portion for movement between an in-line position and a position inclined towards the handgrip portion of the other lever, and in that there is provided disengageable latching means between the handgrip portion and the shank portion and which is engaged when the handgrip portion is in line with the shank portion, spring means within the handgrip portion urging the latching means towards engagement, adjustment means on the handgrip portion for setting the loading of the spring means on the latching means, and scale means associated with the adjustment means for indicating the load settings.

2. A tool as in claim 1, characterised in that articulation of the handgrip portion to the shank portion is afforded by mounting the handgrip portion on a shaft extending from a transverse pivot within the shank portion, with an interface between the handgrip portion and the shank portion there being an aperture in the end face of the shank portion for passage of the shaft, and the latching means being incorporated at the interface.

3. A tool as in claim 2, characterised in that the interface is formed as a part-cylindrical surface having the pivot axis as its centre of curvature.

4. A tool as in claim 2 or claim 3, characterised in that the aperture is a slot for limiting the swing of the shaft and with it the handgrip portion.

5. A tool as in any one of claims 1 to 4, characterised in that the latching means comprises at least two balls symmetrically disposed one to either side of the shaft and each housed in a socket in the end face of the handgrip portion and, when the handgrip portion is in line with the shank portion, protruding slightly into the rim of a hole having a diameter less than the ball in the end face of the shank portion.

6. A tool as in any one of claims 1 to 4, characterised in that the latching means comprises at least one cylindrical bar disposed with its axis parallel to the axis of the pivot of the shaft and housed in a groove in the end face of the handgrip portion and, when the handgrip portion is in line with the shank portion, protruding into a groove in the end face of the shank portion.

7. A tool as in claim 6, characterised in that a second cylindrical bar is provided parallel with the first cylindrical bar, with the second cylindrical bar housed in a groove in a lateral extension of the end of the shank portion and, when the handgrip portion is in line with the shank portion, protruding into a groove in a lateral extension of the end of the handgrip portion.

8. A tool as in claim 7, characterised in that the groove in the laterally extended end of the handgrip portion for the second bar has a tangential ramp towards the first bar up towards a stop for the second bar when the latching means becomes disengaged, which contact enhances the audible click upon disengagement.

9. A tool as in claim 7 or claim 8, characterised in that the lateral extensions extend towards the other handgrip portion, for compactness.

10. A tool as in claim 9, characterised in that the lateral extensions constitute stop means between the handgrip portions, additional or alternative to stop means between the shank portions.

11. A tool as in claim 10, characterised in that complementary stop means are provided at the juncture of the handgrip and shank portions of the other lever to guard against trapping of fingers between the two stop means.

12. A tool as in any one of claims 7 to 11, characterised in that the laterally extended end of the handgrip portion has upstanding flanges along its sides to retain the cylindrical bars in their respective grooves, and the flanges are slidably located in grooves in the laterally extended end of the shank portion, to guide the handgrip portion in its movements relative to the shank portion.

13. A tool as in claim 12, characterised in that outer flanks of the grooves are contiguous with a semicircular skirt portion on the end face of the shank portion and lying outside an upstanding semicircular flange portion on the end face of the handgrip portion contiguous with the flanges thereon, to preclude ingress of dirt into the latching means.

14. A tool as in any one of claims 1 to 13, characterised in that the spring means is a helical coil compression spring encircling the shaft within the handgrip portion, one end of the spring abutting an annular shoulder within the handgrip portion facing oppositely to the end face of the handgrip portion and the other end abutting an annular member slidable on the shaft and backed by a nut screwing along a threaded end portion of the shaft, the nut being slidable but non-rotatable in a blind hole in an end-cap captive in the handgrip portion and rotatable with respect to the handgrip portion for effecting axial movement of the nut and annular member for adjusting the loading of the spring, and the annular member having a pointer projecting radially through an axial slot in one side of the handgrip portion to register against a scale indicative of the tension to be applied to a wire.

15. A tool as in any one of claims 1 to 14, characterised in that the articulation between a handgrip portion and a shank portion is provided on the second lever.

16. A tool as in claim 15, characterised in that the first lever is jointed at a third pivot between a first shank portion carrying the first handgrip portion and a bracket portion carrying both the abutment portion and the first pivot, with a first arcuate gear portion at the end of the first shank portion remote from the first handgrip portion and in that the second lever is provided with a second shank portion carrying the second handgrip portion and a second arcuate gear portion concentric with the first pivot and meshing with the first arcuate gear portion.

17. A tool as in any one of claims 1 to 16, characterised in that the abutment portion of the first lever is provided with a notch for location of a wire extending from a terminal or connector to between the clamping members on the second lever, whereby the terminal or connector is located against the second abutment face.

18. A tool as in any one of claims 1 to 17, characterised in that the second abutment face is recessed for receipt of one end of a terminal or connector.

19. A wire pulling and tensioning tool substantially as hereinbefore described with reference to FIGS. 1 to 11 of the accompanying drawings.

20. A tool as in claim 19 with alternative latching means substantially as hereinbefore described with reference to FIGS. 12 to 17 of the accompanying drawings.
